(19) United States
(12) Patent Application Publication
(10) Pub. No.: US 2018/0145866 A1
(43) Pub. Date: May 24, 2018

(54) STORAGE SYSTEM ENCLOSURES

(71) Applicant: Hewlett Packard Enterprise Development LP, Houston, TX (US)

(72) Inventors: Dave PRESTON, Houston, TX (US); Bradley G. CULTER, Houston, TX (US)

(21) Appl. No.: 15/568,104

(22) PCT Filed: Apr. 22, 2015
(86) PCT No.: PCT/US2015/027177

§ 371 Date: Oct. 20, 2017

(51) Int. Cl. H04L 29/08; G06F 11/30; H04L 12/28

(52) U.S. Cl. CPC H04L 29/08; H04L 67/125; H04L 67/1097; H04L 12/28; H04L 67/104; G06F 11/3006

(57) ABSTRACT

The present subject matter relates to an enclosure of a storage system. Each node of the enclosure comprises: at least two peer-to-peer connected class-A ESP devices to redundantly monitor and control a first set of environmental components shared within a respective node by the at least two class-A ESP devices; at least one class-B ESP device peer-to-peer connected to at least one class-B ESP device of another node in the enclosure to redundantly monitor and control a second set of environmental components shared between the respective node and the other node; and at least one class-X EM device peer-to-peer connected to the at least two class-A ESP devices and the at least one class-B ESP device of the respective node, and to a class-X EM device of the other node to redundantly supervise the monitoring and controlling of the first set and the second set of environmental components.

### BACKGROUND

Storage systems, such as network-attached storage (NAS) systems and storage-area network (SAN) systems, deploy enclosures for storing data and for sharing the data with clients. An enclosure of a storage system may function as a network node between the storage system and the clients. The enclosure has a variety of components, for example, sensors, fans, power supplies, memories, controllers, and processors, that may have to be managed, i.e., monitored and controlled for reliable and efficient operation of the storage system.

### BRIEF DESCRIPTION OF DRAWINGS

The following detailed description references the drawings, wherein:

FIG. 1 illustrates an enclosure of a storage system, according to an example implementation of the present subject matter;

FIG. 2 illustrates an enclosure of a storage system, according to an example implementation of the present subject matter;

FIG. 3 illustrates a method for managing a plurality of nodes in an enclosure of a storage system, according to an example implementation of the present subject matter;

FIG. 4 illustrates a method for managing a plurality of nodes in an enclosure of a storage system, according to an example implementation of the present subject matter; and

FIG. 5 illustrates an example system environment for managing a plurality of nodes in an enclosure of a storage system, according to an example implementation of the present subject matter.

### DETAILED DESCRIPTION

Enclosures may be utilized in a storage system for storing data and for sharing the data with clients. An enclosure generally has a plurality of nodes, where each of the plurality of nodes may include components, such as sensors, fans, power supplies, memories, controllers, and processors. The components in each of the plurality of nodes may have to be monitored and controlled for reliable and efficient operation of the storage system.

Information related to the operational status of the components and interconnections between the components of a node of the enclosure may be collected for monitoring and controlling the components. The information may include status of power supplies, temperature of the enclosure or the components within the enclosure, fan speed, status and available bandwidth of interconnections, and such. The collected information may be provided to a remote host device through which the information may be assessed to determine health status of the components. Based on the health status, a fault in a component may be diagnosed and a recovery action based on the fault may be initiated on the component from the remote host device.

Generally, the information related to the operational status of the components of a node of the enclosure is collected, and provided to the remote host device, by a single processing device in the node. In case the processing device fails, the information may not be collected and hence diagnostics and recovery actions may not be performed for the node of the enclosure. The absence of diagnostics and recovery actions may adversely affect the resilience and the availability of the node of the enclosure for data storage.

Further, the information related to the operational status of the components may be collected by the processing device by poling the components. The poling utilizes central processing unit (CPU) cycles. In case the processing device that collects the information is a storage processor, the poling may interfere with the data storage. In such a case, the data storage may have to be interrupted during the poling for collecting the information.

The present subject matter describes an enclosure of a storage system and management of a plurality of nodes in the enclosure of the storage system. In the management of the plurality of nodes in the enclosure according to the present subject matter, components that are utilized for the operation of the enclosure may be redundantly monitored and controlled by two or more processing devices of a same class. The monitoring and controlling of the components by the processing devices of a class may further be redundantly supervised by two or more processing devices of another class.

The components may include environmental components, such as fans, power supplies, sensors, and the like. The monitoring and controlling of components by a processing device may include monitoring of health status of the components and performing a component management action, for example, switch OFF/ON or reset, on one or more components based on the health status. The redundant monitoring and controlling of the components by one class of processing devices, and the redundant supervision of the monitoring and controlling of the components by another class of processing devices provide a two-stage redundancy with respect to management of components in the nodes of the enclosure. With the two-stage redundancy in the management of components, in accordance with the present subject matter, even if a processing device of a class fails, another processing device of the same class or a different class can continue to monitor and control the components. This provides high availability of monitoring and controlling of the components, i.e., continuous monitoring and controlling of the components. The high availability of monitoring and controlling of the components enables increasing the resilience of the nodes of the enclosure, makes the enclosure robust, and provides high availability of the nodes of the enclosure for data storage. The high availability of nodes herein may refer to availability of the nodes, with minimum, nearing to zero, down-time.

In an example implementation of the present subject matter, each node in the enclosure may include a first set of environmental components that are shared within a respective node by at least two environmental sub-processing (ESP) devices of a same class, for example, class-A. A class-A ESP device in a node functions to monitor and control the first set of environmental components for the purposes of data storage. At least two class-A ESP devices in the node are peer-to-peer connected to each other so that each of the at least two class-A ESP devices can redundantly monitor and control the first set of environmental components.

Further, in an example implementation, the enclosure may include a second set of environmental components that are shared between two nodes in the enclosure for data storage. Each of the two nodes includes at least one ESP device of class-B, which is different from class-A. A class-B ESP device in a node functions to monitor and control the second set of environmental components for data storage. Similar to the case of the class-A ESP devices, the at least one class-B ESP device in one of the nodes is peer-to-peer connected to the at least one class-B ESP device of the other node to redundantly monitor and control the second set of environmental components.

Furthermore, in an example implementation, each node in the enclosure includes at least one enclosure management (EM) device of a class, for example, class-X. The class-X EM device in a node is peer-to-peer connected to the at least two class-A ESP devices and the at least one class-B ESP device in that node to supervise the monitoring and controlling of the first set of environmental components and the second set of environmental components. The class-X EM device in the node is also peer-to-peer connected to a class-X EM device of another node to redundantly supervise the monitoring and controlling of the first set of environmental components and the second set of environmental components.

With reference to the configuration of various components in the enclosure, the class-A ESP devices and the class-B ESP devices in a node function as subordinate processing devices for monitoring and controlling the environmental components shared within the node and across multiple nodes. The class-X EM device in a node functions as supervisory processing device for supervising the monitoring and controlling of the environmental components. Further, the peer-to-peer connections between ESP devises of a class, between ESP devices and an EM device, and between EM devices of a class provide multiple communication paths that facilitate the redundant monitoring and controlling of the environmental components, and the redundant supervision of the monitoring and controlling of the components in the nodes of the enclosure.

In an example implementation, each of the at least two class-A ESP devices, the at least one class-B ESP device, and the at least one class-X EM device in a node may generate a heart-beat signal and communicate the heart-beat signal to at least one other peer-to-peer connected ESP device or at least one peer-to-peer connected EM device in the node. The heart-beat signal of a device may be indicative of a device functional status, i.e., whether the device is functionally active or not. Along with the heart-beat signal, each of the at least two class-A ESP devices may communicate health status information of the first set of environmental components to at least one other peer-to-peer connected ESP device or at least one peer-to-peer connected EM device. Similarly, the at least one class-B ESP device may communicate health status information of the second set of environmental components to at least one other peer-to-peer connected ESP device or at least one peer-to-peer connected EM device. With the heart-beat signal and the health status information, the ESP devices and the EM device in a node may be topology-aware with respect to the devices and components in the node. With the topology awareness, the poling may not be performed for the purpose of collection of information. This improves the efficiency of data storage through the enclosure.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

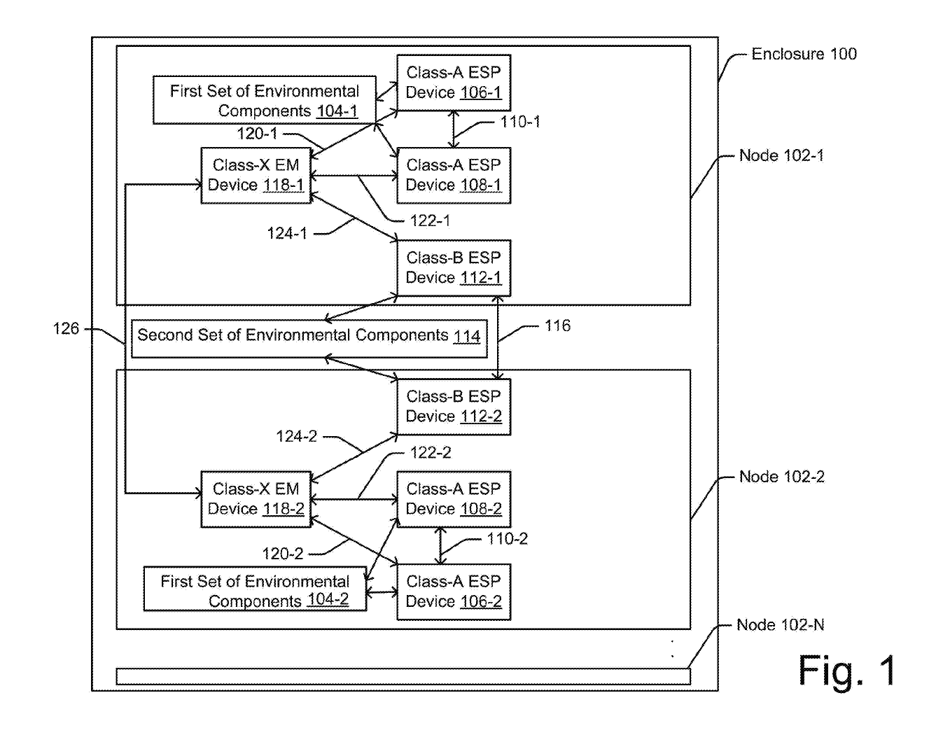

FIG. 1 illustrates an enclosure 100 of a storage system, according to an example implementation of the present subject matter. The enclosure 100 includes a plurality of nodes 102-1, 102-2, . . . , 102-N, hereinafter collectively referred to as nodes 102 and individually referred to as a node 102. The nodes 102 of the enclosure 100 are utilized for storing data and sharing the stored data with external computing resources, such as client devices.

Each node has a first set of environmental components, and two class-A ESP devices that share the first set of environmental components for the operation of a respective node for data storage. The two class-A ESP devices are connected to the first set of environmental components for monitoring and controlling the first set of environmental components. As shown in FIG. 1, a first node 102-1 has the first set of environmental components 104-1 and two class-A ESP devices 106-1 and 108-1 connected to the first set of environmental components 104-1. Similarly, a second node 102-2 has the first set of environmental components 104-2 and two class-A ESP devices 106-2 and 108-2 connected to the first set of environmental components 104-2. The two class-A ESP devices in each node are peer-to-peer connected to each other. The peer-to-peer connection between the two class-A ESP devices 106-1 and 108-1 in the first node 102-1 is referenced by 110-1, and the peer-to-peer connection between the two class-A ESP devices 106-2 and 108-2 in the second node 102-2 is referenced by 110-2. The peer-to-peer connection between the two class-A ESP devices enables redundantly monitoring and controlling of the first set of environmental components by each of the two class-A ESP devices. Although, each node is shown to have two class-A ESP devices, in an example implementation, each node may have more than two class-A ESP devices. In the case of more than two class-A ESP devices in a node, two of the class-A ESP devices, pair-wise, share an individual set of environmental components within the node and are peer-to-peer connected to each other for the redundant monitoring and controlling of the shared individual set of environmental components.

Each node also has a class-B ESP device that shares a second set of environmental components with a class-B ESP device of another node for the operation of the respective node for data storage. The class-B ESP device in the node is connected to the second set of environmental components for monitoring and controlling the second set of environmental components. As shown in FIG. 1, the first node 102-1 has the class-B ESP device 112-1 connected to the second set of environmental components 114. Similarly, the second node 102-2 has the class-B ESP device 112-2 connected to the second set of environmental components 114. The class-B ESP device in a node is peer-to-peer connected to the class-B ESP device in another node. The peer-to-peer connection between the class-B ESP device 112-1 in the first node 102-1 and the class-B ESP device 112-2 in the second node 102-2 is referenced by 116. The peer-to-peer connection 116 between the class-B ESP devices across the nodes 102 enables redundantly monitoring and controlling of the second set of environmental components by each of the class-B ESP devices. Although, each node is shown to have one class-B ESP device, in an example implementation, each node may have more than one class-B ESP device. In the case of more than one class-B ESP device in a node, each class-B ESP device in the node shares an individual set of environmental components across two nodes and is peer-to-peer connected to a class-B ESP device in the other node for the redundant monitoring and controlling of the individual set of environmental components.

Each node further has at least one class-X EM device that is peer-to-peer connected to at least two class-A ESP devices and at least one class-B ESP device within the respective node for supervising the monitoring and controlling performed by the at least two class-A ESP devices and the at least one class-B ESP device within the node. As shown in FIG. 1, the first node 102-1 has a class-X EM device 118-1 peer-to-peer connected to the two class-A ESP devices 106-1 and 108-1 and to the class-B ESP device 112-1. The peer-to-peer connections between the class-X EM device 118-1 and the two class-A ESP devices 106-1 and 108-1 and the class-B ESP device 112-1, respectively, is referenced by 120-1, 122-1, and 124-1. Similarly, the second node 102-2 has a class-X EM device 118-2 peer-to-peer connected to the two class-A ESP devices 106-2 and 108-2 and to the class-B ESP device 112-2. The peer-to-peer connections between the class-X EM device 118-2 and the two class-A ESP devices 106-2 and 108-2 and the class-B ESP device 112-2, respectively, is referenced by 120-2, 122-2, and 124-2.

Further, at least one class-X EM device in a node is peer-to-peer connected to at least one class-X EM device in another node. As shown in FIG. 1, the peer-to-peer connection between the class-X EM device 118-1 in the first node 102-1 and the class-X EM device 118-2 in the second node 102-2 is referenced by 126. The peer-to-peer connection between the class-X EM devices across two nodes enables redundantly supervising the monitoring and controlling of the first set of environmental components and the second set of environmental components by each of the class-X EM devices across the two nodes.

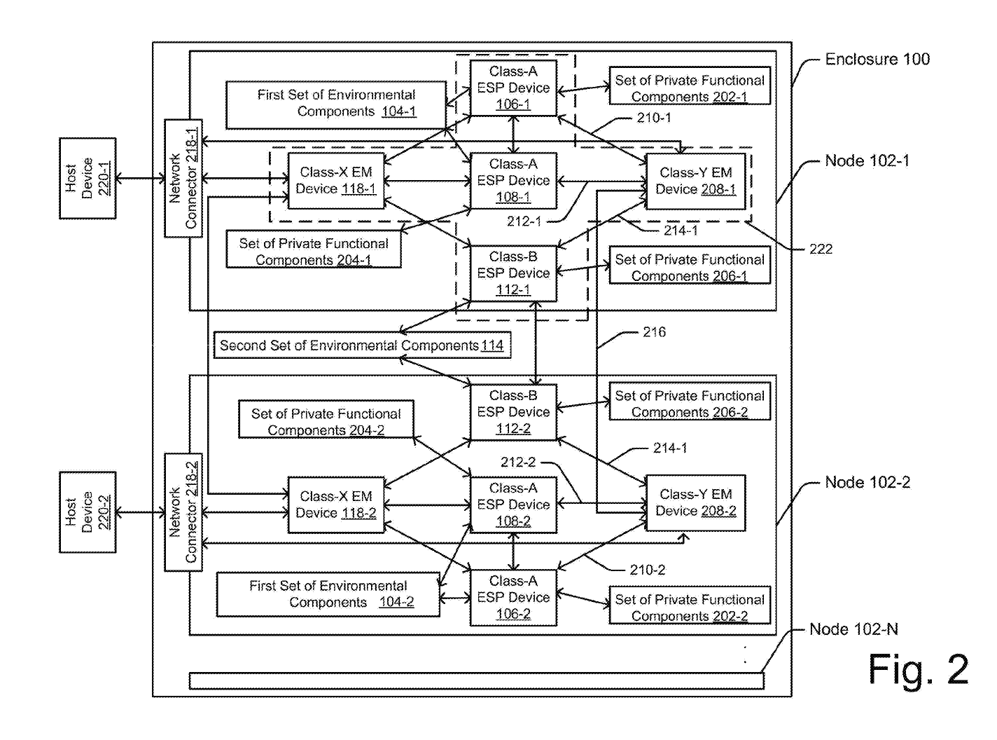

Details on the redundant monitoring and controlling of the first set and the second set of environmental components by the peer-to-peer connected ESP devices, and the redundant supervising the monitoring and controlling by the peer-to-peer connected EM devices are provided later in the description with reference to FIG. 2.

In an example implementation, the first set and the second set of environmental components may include one or more of fans, power supplies, sensors, indicators, and such. The sensors may include temperature sensors, humidity sensors, and such. In an example implementation, the first set and the second set of environmental components may include same or different combinations of components depending on the role and the function of the associated ESP device. Examples of roles and functionality may include, but is not restricted to, power management, security management, circuit health management, data collection, and such.

In an example implementation, the peer-to-peer connections between the class-A ESP devices, the class-B ESP devices, and the class-X EM devices in a node may be direct peer-to-peer connections or functional peer-to-peer connections. A direct peer-to-peer connection between two devices may, for example, refer to a direct wire link between the two devices which operates on a suitable communication protocol. A functional peer-to-peer connection between two devices may, for example, refer to an indirect link between the two devices via one or more middle devices. In an example, in the first node 102-1, the peer-to-peer connection 120-1 between the class-X EM device 118-1 and the class-A ESP device 106-1 can be a direct wire link. In another example, the peer-to-peer connection 120-1 between the class-X EM device 118-1 and the class-A ESP device 106-1 can be an indirect link via the other class-A ESP device 108-1.

In an example implementation, a peer-to-peer connection, from among the peer-to-peer connections between the class-A ESP devices, the class-B ESP device, and the class-X EM devices, may be one of a Serial RS232 connection, a single wire connection, a shared memory connection, an I-squared-C (I2C) connection, a half-duplex internet protocol (HDIP) connection, and a local area network (LAN) connection.

FIG. 2 illustrates the enclosure 100 of the storage system, according to an example implementation of the present subject matter. FIG. 2 illustrates additional components, devices, and connections in the enclosure 100 in comparison to the components, devices, and connections shown in FIG. 1.

In each node, each of the class-A ESP devices and the class-B ESP devices is connected to a respective set of private functional components for the operation of the respective node for data storage. A private functional component for a device in a node may refer to a component that is private to the device and is not shared by any other device in the node. As shown in FIG. 2, in the first node 102-1, each of the two class-A ESP devices 106-1 and 108-1 is connected to a respective set of private functional components 202-1 and 204-1, and the class-B ESP device 112-1 is connected to a set of private functional components 206-1. Similarly, in the second node 102-2, each of the two class-A ESP devices 106-2 and 108-2 is connected to a respective set of private functional components 202-2 and 204-2, and the class-B ESP device 112-2 is connected to a set of private functional components 206-2. Each of the class-A ESP devices and the class-B ESP devices in a node functions to monitor and control its respective set of private functional components.

In an example implementation, a set of private functional components may include one or more of sensors, accelerometers, radio-frequency (RF) transceivers, security devices, voltage regulators, inventors, variable capacitors, A/D and D/A convertors, CPUs, I/O controllers, memory controllers, and such. The sensors may include voltage sensors, current sensors, temperature sensors, humidity sensors, magnetic field sensors, position sensors, light sensors, and such. Each set of private functional components may include a same or a different combination of components depending on the role and the functionality of the associated ESP device. Examples of roles and functionality may include, but is not restricted to, power management, security management, circuit health management, data collection, and such.

Further, each node includes at least one class-Y EM device that provides at least one system-level service function to external computing resources. The external computing resources may include client devices, and the system-level service function may include, but is not restricted to, a data storage service, a data computation service, and such. As shown in FIG. 2, the first node 102-1 includes a class-Y EM device 208-1, and the second node 102-2 includes a class-Y EM device 208-2. The external computing resources may communicate with the class-Y EM devices 208-1, 208-2 of the nodes 102 over a network, for example, a storage area network (SAN).

In each node, at least one class-Y EM device is peer-to-peer connected to at least two class-A ESP devices and at least one class-B ESP device within the respective node for supervising the monitoring and controlling performed by the at least two class-A ESP devices and the at least one class-B ESP device within the node. As shown in FIG. 2, the first node 102-1 has the class-Y EM device 208-1 peer-to-peer connected to the two class-A ESP devices 106-1 and 108-1 and to the class-B ESP device 112-1. The peer-to-peer connections between the class-Y EM device 208-1 and the two class-A ESP devices 106-1 and 108-1 and the class-B ESP device 112-1, respectively, is referenced by 210-1, 212-1, and 214-1. Similarly, the second node 102-2 has the class-Y EM device 208-2 peer-to-peer connected to the two class-A ESP devices 106-2 and 108-2 and to the class-B ESP device 112-2. The peer-to-peer connections between the class-Y EM device 208-2 and the two class-A ESP devices 106-2 and 108-2 and the class-B ESP device 112-2, respectively, is referenced by 210-2, 212-2, and 214-2.

Further, at least one class-Y EM device in a node is peer-to-peer connected to at least one class-Y EM device in another node. As shown in FIG. 2, the peer-to-peer connection between the class-Y EM device 208-1 in the first node 102-1 and the class-Y EM device 208-2 in the second node 102-2 is referenced by 216. The peer-to-peer connection between the class-Y EM devices across two nodes enables redundantly supervising the monitoring and controlling of the first set of environmental components and the second set of environmental components and redundantly providing the at least one system-level service function by each of the class-Y EM devices.

Further, at least one class-Y EM device in a node is peer-to-peer connected to at least one class-X EM device in that node. The peer-to-peer connection between the class-Y EM device and the class-X EM device within the same node enables the redundantly supervising the monitoring and controlling with respect to each other.

For the purpose of monitoring and controlling the environmental components and the private functional components, in an example implementation, each of the ESP devices in each node may function to fetch health status information of the associated environmental components and the associated private functional components. Based on the health status information, an ESP device may initiate a component management action on an associated environmental component or an associated private functional component. For example, each of the class-A ESP devices in a node may fetch the health status information of the first set of environmental components and of the respective set of private functional components. Based on the health status information, each of the class-A ESP devices may initiate a component management action on an environmental component from the first set of environmental components or a private functional component from its respective set of private functional components. The component management action may include, but is not restricted to, component reset, component switch OFF/ON, modify a component operating condition, and such. In an example, in the first node 102-1, if the health status information associated with a temperature sensor, from the first set of environmental components 104-1, indicates that the temperature of the first node 102-1 is high, then each of the class-A ESP devices 106-1 and 108-1 may initiate a component management action on one or more fans, from the first set of environmental components 104-1, to increase the fan speed.

Similarly, the class-B ESP device in a node may fetch the health status information of the second set of environmental components and of the respective set of private functional components. Based on the health status information, the class-B ESP device may initiate a component management action on an environmental component from the second set of environmental components or a private functional component from its respective set of private functional components.

Further, as shown in FIG. 2, in each node 102, the two class-A ESP devices, the class-B ESP device, the class-X EM device, and the class-Y EM device form a set of devices in a communication mesh. The communication mesh in the first node 102-1 is referenced by 222. The peer-to-peer connections between the ESP devices and the EM devices, as described earlier, enable the formation of the communication mesh. In an example implementation, each of the two class-A ESP devices in a node functions to communicate the health status information of the first set of environmental components and of its respective set of private functional components to at least one device of the set of devices in the communication mesh. For example, in the first node 102-1, the class-A ESP device 106-1 may communicate the health status information of the first set of environmental components 104-1 and of the set of private functional components 202-1 to at least one of the class-X EM device 118-1 and the class-Y EM device 208-1. The class-A ESP device 106-1 may communicate the health status information so that the at least one of the class-X EM device 118-1 and the class-Y EM device 208-1 can supervise the monitoring and controlling of the first set of environmental components 104-1 and the set of private functional components 202-1. In this supervisory monitoring and controlling, the at least one of the class-X EM device 118-1 and the class-Y EM device 208-1 can initiate the component management action on an environmental component, from the first set of environmental components 104-1, and on a private functional component, from the respective set of private functional components 202-1, when the component management action is not initiated by any of the class-A ESP devices 106-1 and 108-1. The component management action may be initiated by the at least one of the class-X EM device 118-1 and the class-Y EM device 208-1 based on the health status information.

In an example implementation, the class-B ESP device in a node functions to communicate the health status information of the second set of environmental components and of its respective set of private functional components to at least one device of the set of devices in the communication mesh 222. For example, in the first node 102-1, the class-B ESP device 112-1 may communicate the health status information of the second set of environmental components 114 and of the set of private functional components 206-1 to at least one of the class-X EM device 118-1 and the class-Y EM device 208-1. The class-B ESP device 112-1 may communicate the health status information so that the at least one of the class-X EM device 118-1 and the class-Y EM device 208-1 can supervise the monitoring and controlling of the second set of environmental components 114 and the set of private functional components 206-1. In this supervisory monitoring and controlling, the at least one of the class-X EM device 118-1 and the class-Y EM device 208-1 can initiate the component management action on an environmental component, from the second set of environmental components 114, and on a private functional component, from the respective set of private functional components 206-1, when the component management action is not initiated by the class-B ESP device 112-1. The component management action may be initiated by the at least one of the class-X EM device 118-1 and the class-Y EM device 208-1 based on the health status information.

Further, in an example implementation, in a node, one class-A ESP device may communicate the health status information of the first set of environmental components to the other class-A ESP device in the node through the peer-to-peer connection. This enables the two class-A ESP devices to redundantly monitor and control the first set of environmental components shared between the two class-A ESP devices. Similarly, in an example implementation, the class-B ESP device in a node may communicate the health status information of the second set of environmental components to the class-B ESP device of the other node through the peer-to-peer connection. This enables the two class-B ESP devices, across the two nodes, to redundantly monitor and control the second set of environmental components shared between the two class-B ESP devices.

Further, in an example implementation, the class-X EM device in a node may communicate the health status information of the first set of environmental components, the second set of environmental components, and various sets of private functional components in that node, to the class-X EM device of the other node through the peer-to-peer connection. This enables the two class-X EM devices, across the two nodes, to redundantly supervise the monitoring and controlling of the first set of environmental components, the second set of environmental components, and the various sets of private functional components.

In an example implementation, each of the ESP devices and the EM devices in each node may possess a unique device identifier (ID). The unique device ID may be, for example, in the form of a binary or a hexadecimal number. Each ESP device and each EM device in a node may communicate the associated unique device ID to another ESP device and another EM device within that node or in a different node, while communicating the health status information. The unique device ID enables the recipient ESP device or the recipient EM device to distinguish and determine a peer-to-peer connected source device from which the health status information is originated and communicated. For example, in the first node 102-1, the class-X EM device may receive the health status information of the first set of environmental components 104-1 and the second set of environmental components 114 from the class-A ESP device 106-1 and the class-B ESP device 112-1, respectively. The class-A ESP device 106-1 and the class-B ESP device 112-1 may communicate the respective unique device ID to the class-X EM device 118-1 while sending the health status information. With this, the class-X EM device 118-1 can distinguish and determine the health status information that is communicated by the class-A ESP device 106-1 and the health status information that is communicated by the class-B ESP device 112-1. The class-X EM device 118-1 may utilize the unique device ID to direct the component management action distinguishably to the class-A ESP device 106-1 or the class-B ESP device 112-1, as the case maybe.

Further, in an example implementation, each of the two class-A ESP devices, the class-B ESP device, the class-X EM device, and the class-Y EM device in each node may generate a heart-beat signal and communicate the heart-beat signal to at least one device of the set of devices in the communication mesh in the node. The heart-beat signal of a device may be indicative of a device functional status, i.e., whether the device is functional active or inactive. In an example, the device functional status may be configured, for example, in the form of a binary bit, having a status of ‘0’ or ‘1’ to indicative active status or inactive status. Each of the two class-A ESP devices, the class-B ESP device, the class-X EM device, and the class-Y EM device may also communicate the associated unique device ID, along with the heart-beat signal. The unique device ID along with the heart-beat signal enable the recipient ESP device and the recipient EM device to distinguish and determine the other peer-to-peer connected ESP device or EM device that is active and available for redundantly monitoring and controlling, and supervising the monitoring and controlling of the first set of environmental components, the second set of environmental components, and the various sets of private functional components. The communication of the heart-beat signal along with the unique device ID of a device with one or more of other devices in the communication mesh enables determination of redundancy topology within the nodes 102 of the enclosure 100.

For example, in the first node 102-1, the class-A ESP devices 106-1 and 108-1 may communicate the respective heart-beat signal along with the unique device ID to each other. With this, each of the class-A ESP devices 106-1 and 108-2 can determine whether the other is active for monitoring and controlling the first set of environmental components 104-1. If one class-A ESP device, say 106-1, fails, then the other class-A ESP device 108-1 can determine, based on the heart-beat signal, that the class-A ESP device 106-1 is inactive and thus can initiate the component management action on an environmental component from the first set of environmental components 104-1, based on the health status information.

Similarly, in an example, in the first node 102-1, each of the class-A ESP devices 106-1 and 108-1 may communicate the respective heart-beat signal along with the unique device ID to the class-X EM device 118-1. With the heart-beat signal and the unique device ID, the class-X EM devices 118-1 can determine whether any of the class-A ESP devices 106-1 and 108-1 is active for monitoring and controlling the first set of environmental components 104-1. If one class-A ESP device, 106-1, fails, then the class-X EM device 118-1 can determine, based on the heart-beat signal, that the class-A ESP device 106-1 is inactive and thus can supervise the monitoring and controlling of the first set of environmental components 104-1 through the other class-A ESP device 108-1. In the supervisory monitoring and controlling, the class-X EM device 118-1 can initiate the component management action on an environmental component from the first set of environmental components 104-1, through the other class-A ESP device 108-1, which is active.

Further, in an example, in the first node 102-1, the class-X EM device 118-1 and the class-Y EM device 208-1 may communicate the respective heart-beat signal along with the unique device ID to each other. With the heart-beat signal and the unique device ID, each of the class-X EM devices 118-1 and the class-Y EM device 208-2 can determine whether the other is active for supervising the monitoring and controlling the first set of environmental components 104-1 or the second set of environmental components 114, or the various sets of private functional components 202-1, 204-1, 206-1. If the class-X EM device 118-1 fails, then the class-Y EM device 208-1 can determine, based on the heart-beat signal, that the class-X EM device 118-1 is inactive and thus can supervise the monitoring and controlling of the first set of environmental components 104-1, or the second set of environmental components 114, or the various sets of private functional components 202-1, 204-1, 206-1, as the case maybe. In the supervisory monitoring and controlling, the class-Y EM device 208-1 can initiate the component management action on one or more components from the first set of environmental components 104-1, or the second set of environmental components 114, or the various sets of private functional components 202-1, 204-1, 206-1.

Further, in an example implementation, the peer-to-peer connected class-B ESP devices 112-1 and 112-2 across the first node 102-1 and the second node 102-2 may communicate the respective heart-beat signal along with the unique device ID to each other. With the heart-beat signal and the unique device ID, each of the class-B ESP devices 112-1 and 112-2 can determine whether the other is active for monitoring and controlling the second set of environmental components 114. If one class-B ESP device, say 112-1, fails, then the other class-B ESP device 112-2 can determine, based on the heart-beat signal, that the class-B ESP device 112-1 is inactive and thus can initiate the component management action on an environmental component from the second set of environmental components 114, based on the health status information.

Further, in an example implementation, the peer-to-peer connected class-X EM devices 118-1 and 118-2 across the first node 102-1 and the second node 102-2 may communicate the respective heart-beat signal along with the unique device ID to each other. With the heart-beat signal and the unique device ID, each of the class-X EM devices 118-1 and 118-2 can determine whether the other is active for supervising the monitoring and controlling the first set of components 104-1, 104-2, the second set of environmental components 114, and the various sets of private functional components, in the first node 102-1 and the second node 102-2. When both the class-X EM devices 118-1 and 118-2 are active, then any of the class-X EM devices 118-1 and 118-2 can initiate the component management action on one or more components from the first set of environmental components, or the second set of environmental components, or the various sets of private functional components. In an example, the class-X EM device 118-1 in the first node 102-1 can initiate a component management action on an environmental component from the first set of environmental components 104-2 in the second node 102-2 through the class-X EM device 118-2, and the class-A ESP device 108-2 or 106-2. In an example, the class-X EM device 118-2 in the second node 102-2 can initiate a component management action on an environmental component from the second set of environmental components 114 through the class-X EM device 118-1 and the class-B ESP device 112-1. It may be noted that the peer-to-peer connections within each node and across the nodes provides multiple and alternate paths for initiating and directing a component management action towards an environmental component or a private functional component.

Further, in an example implementation, the peer-to-peer connected class-Y EM devices 208-1 and 208-2 across the first node 102-1 and the second node 102-2 may communicate the respective heart-beat signal along with the unique device ID to each other. With the heart-beat signal and the unique device ID, each of the class-Y EM devices 208-1 and 208-2 can determine whether the other is active for supervising the monitoring and controlling the first set of components 104-1, 104-2, the second set of environmental components 114, and the various sets of private functional components, in the first node 102-1 and the second node 102-2. When both the class-Y EM devices 208-1 and 208-2 are active, then any of the class-Y EM devices 208-1 and 208-2 can initiate the component management action on one or more components from the first set of environmental components, or the second set of environmental components, or the various sets of private functional components.

In an example implementation, apart from the component management action, each of the class-A ESP device, the class-B ESP device, the class-X EM device, and the class-Y EM device in each node may function to initiate one or more other actions related to, for example, fetch topology, fetch functionality, forward a message, suspend a function, start a function, and such. In the action related to fetch topology, a device may request for the heart-beat signal from other peer-to-peer connected devices within the node or across the nodes. In the action related to fetch functionality, a device may request for information indicative of functionality of one or more other peer-to-peer connected devices within the node or across the nodes. In the action related to forward a message, a device may forward a message from one peer-to-peer connected device to another peer-to-peer connected device within the node or across the nodes. In the action related to suspend a function, a device may stop the functioning of itself or one or more other peer-to-peer connected devices within the node or across the nodes. In the action related to start a function, a device may start a function in itself or in one or more other peer-to-peer connected devices within the node or across the nodes. In an example, the action may also include device switch OFF/ON, in which a device may switch OFF or ON one or more other peer-to-peer connected devices within the node or across the nodes. In an example, the action may also include device reset, in which a device may reset one or more other peer-to-peer connected devices within the node or across the nodes.

In an example implementation, in the enclosure 100, the class-X EM devices in at least two nodes 102 are respectively connected to at least one network connector such that the class-X EM device in each of the at least two nodes 102 can be connected to one or more host devices through the at least one network connector. As shown in FIG. 2, the class-X EM device 118-1 in the first node 102-1 is connected to a network connector 218-1, and the class-X EM device 118-2 in the second node 102-2 is connected to a network connector 218-2. Further, as shown in FIG. 2, the class-X EM device 118-1 in the first node 102-1 is connected to a host device 220-1 through the network connector 218-1, and the class-X EM device 118-2 in the second node 102-2 is connected to a host device 220-2 through the network connector 218-2. Although a single network connector 218-1, 218-2 and a single host device 220-1, 220-2 are shown for each node, in an example implementation, the class-X EM device in each node may be connected to more than one network connector, and the class-X EM device in each node may be connected to more than one host device.

In an example, the network connector 218-1, 218-2 may be a serial connector for locally connecting the host device 220-1, 220-2 to the class-X EM device 118-1, 118-2. In an example, the network connector 218-1, 218-2 may be a LAN connector for remotely connecting the host device 220-1, 220-2 to the class-X EM device 118-1, 118-2.

In an example implementation, the class-Y EM devices in at least two nodes 102 are respectively connected to at least one network connector to which the class-X EM device is connected. The class-Y EM device in each of the at least two nodes 102 is connected to the at least one network connector such that the class-Y EM device can be connected to one or more host devices. As shown in FIG. 2, the class-Y EM device 208-1 in the first node 102-1 is connected to the network connector 218-1, and the class-Y EM device 208-2 in the second node 102-2 is connected to the network connector 218-2.

The connection of host devices with the class-X and the class-Y EM devices in two nodes 102 and the peer-to-peer connection between the class-X and the class-Y EM devices across the two nodes 102 allows the host devices to redundantly monitor and control the first set of environmental components, the second set of environmental components, and the various sets of private functional components of each of the two nodes 102. For monitoring and controlling of components of a node through a host device, the host device can be connected to the network connector, and the health status information of the components of the node along with the heart-beat signals and the unique device IDs associated with the ESP devices and the EM devices in the node may be provided to the host device through the class-X EM device or the class-Y EM device. Based on the health status information, the heart-beat signal, and the unique device ID, the host device can initiate and direct a component management action towards an environmental component or a private functional component, as the case maybe, through the class-X or the class-Y EM device and an active class-A ESP device or an active class-B ESP device in the node.

The peer-to-peer connections between the class-A ESP devices, the class-B ESP devices, the class-X EM devices and the class-Y EM devices provide multiple and alternate communication paths for communicating the component management action from the host device to an environmental component or a private functional component in a node.

For example, a component management action can be communicated to an environmental component of the first set 104-1 from the host device 220-1 through the class-X EM device 118-1 and the class-A ESP device 106-1. The same action can also be communicated from the host device 220-1 through: (1) the class-X EM device 118-1 and the class-A ESP device 108-1; (2) the class-X EM device 118-1, the class-A ESP device 106-1, and the class-A ESP device 108-1; (3) the class-Y EM device 208-1 and the class-A ESP device 106-1, and so on. Further, the same action can be communicated to the environmental component of the first set 104-1 from the host device 220-2 through: (1) the class-X EM device 118-2, the class-X EM device 118-1 and the class-A ESP device 106-1; and (2) the class-Y EM device 208-2, the class-Y EM device 208-1 and the class-A ESP device 106-1, and so on.

In another example, a component management action can be communicated to a private functional component of the set 206-1 from the host device 220-1 through the class-X EM device 118-1 and the class-B ESP device 112-1. The same action can also be communicated from the host device 220-1 through the class-Y EM device 208-1 and the class-B ESP device 112-1. Further, the same action can be communicated from the host device 220-2 through: (1) the class-X EM device 118-2, the class-X EM device 118-1 and the class-B ESP device 112-1; (2) the class-Y EM device 208-2, the class-Y EM device 208-1 and the class-B ESP device 112-1; and (3) the class-X EM device 118-2, the class-B ESP device 112-2 and the class-B ESP device 112-1, and so on.

Further, the enclosure 100 includes a plurality of power domains for powering the ESP devices, the EM devices, and other components within the nodes 102 of the enclosure 100. In an example implementation, the class-X EM devices in the nodes 102 are powered by a power supply (not shown) of a first power domain, the class-Y EM devices in the nodes 102 are powered by a power supply (not shown) of a second power domain, and the class-A ESP devices and the class-Y ESP devices in the nodes 102 are powered by a power supply (not shown) of a third power domain, from the plurality of power domains. With the plurality of power domains, different sets of devices can be powered ON or OFF individually. In an example implementation, the plurality of power domains may also include other power supplies that power the storage drives and other components within the enclosure 100.

In an example, the class-X EM devices in at least two nodes 102 in the enclosure 100 may be powered by an auxiliary power supply that is always ON. The class-Y EM devices, the class-A ESP devices, and the class-B ESP devices, powered by different power domains, may be powered OFF for some reasons, for example, for saving the power consumption. In this situation, any of the class-X EM devices, powered by the auxiliary power supply, can initiate an action to power ON any of the switched OFF EM devices or the switched OFF ESP devices within the node or across two nodes. In an example, one of the class-X EM devices can be connected to a host device through the network connector, and the host device can initiate an action to power ON any of the switched OFF EM devices or switched OFF ESP devices through the class-X EM device.

In an example implementation, the class-X EM device in at least one node 102 of the enclosure 100 may be connected to a class-X EM device in at least one node of another enclosure through the network connector. The enclosures are of the same storage system. For example, the class-X EM device 118-1 in node 102-1 may be connected to a class-X EM device of a node of another enclosure through the network connector 218-1. This connection enables the class-X EM devices of two nodes across two enclosures to redundantly monitor and control various environmental components or private function components in any of the two enclosures. In an example implementation, the class-X EM devices across the two enclosures may communicate the health status information, the heart-beat signals, and the unique device IDs to each other, so as to enable each of the class-X EM devices to redundantly monitor and control the environmental components or the private functional components across two enclosures.

In an example implementation, each of the class-A ESP devices, the class-B-ESP devices, the class-X EM devices, and the class-Y EM devices include processor(s) that may be implemented as microprocessors, microcomputers, microcontrollers, digital signal processors, central processing units, state machines, logic circuitries, and/or any devices that manipulate signals based on operational instructions. Among other capabilities, the processor(s) may fetch and execute computer-readable instructions stored in a memory coupled to the processor(s). The memory may include any non-transitory computer-readable storage medium including, for example, volatile memory (e.g., RAM), and/or non-volatile memory (e.g., EPROM, flash memory, NVRAM, memristor, etc.). In an example implementation, the processor(s) may execute computer-readable instructions to perform various functions related to monitoring and controlling of components in nodes 102 of the enclosure 100, in accordance with the present subject matter. The functions of the various devices shown in FIG. 1 and FIG. 2 may be provided through the use of dedicated hardware as well as hardware capable of executing computer-readable instructions.

In an example implementation, each of the class-A ESP devices, the class-B-ESP devices, the class-X EM devices, and the class-Y EM devices may include a local memory to store one or more of the health status information, the heart-beat signal, and unique device ID, which is received from a peer-to-peer connected device. The processor(s) in the respective device may forward the stored information, signal, or ID data to another peer-to-peer connected device or a host device.

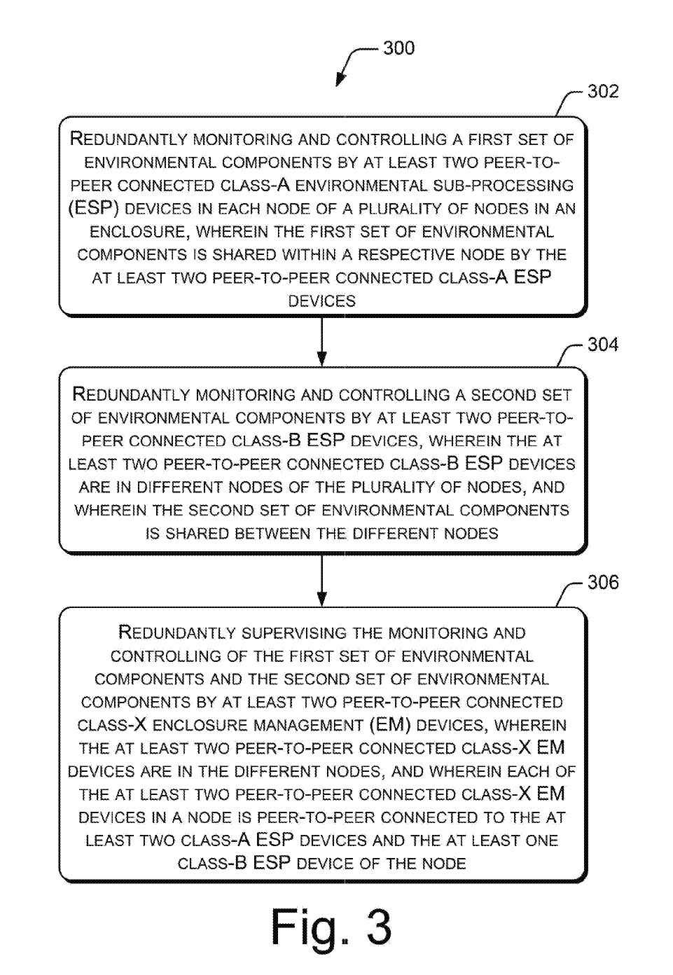

FIG. 3 illustrates a method 300 for managing a plurality of nodes in an enclosure of a storage system, according to an example implementation of the present subject matter. The order in which the method 300 is described is not intended to be construed as a limitation, and any number of the described method blocks can be combined in any order to implement the method 300. Furthermore, the method 300 can be implemented by processor(s) or computing device(s) through any suitable hardware, non-transitory machine readable instructions, or a combination thereof. Further, although the method 300 is described in context of the aforementioned enclosure 100, other suitable computing devices or systems may be used for execution of at least one step of method 300. It may be understood that steps of method 300 can be executed based on instructions stored in a non-transitory computer readable medium. The non-transitory computer readable medium may include, for example, digital memories, magnetic storage media, such as a magnetic disks and magnetic tapes, hard drives, or optically readable digital data storage media.

In an example implementation, the method 300 may be executed in the enclosure 100 having the plurality of nodes 102 as shown in FIG. 1. Each of the plurality of nodes 102 includes at least two class-A ESP devices, at least one class-B ESP device, and at least one class-X EM device. The at least two class-A ESP devices in a node are peer-to-peer connected to each other and are also connected to a first set of environmental components within the respective node. The enclosure 100 also includes a second set of environmental components that are shared across two nodes. The at least one class-B ESP device in each of the two nodes is connected to the second set of environmental components. The at least one class-B ESP device in one of the two nodes is peer-to-peer connected to the at least one class-B ESP device in the other of the two nodes. Further, the at least one class-X EM device in a node is peer-to-peer connected to the at least two class-A ESP devices and the at least one class-B ESP device in that node, and is also peer-to-peer connected to at least one class-X EM device in another node.

Referring to FIG. 3, at block 302, a first set of environmental components is redundantly monitored and controlled by at least two peer-to-peer connected class-A ESP devices in each node of the plurality of nodes 102 of the enclosure 100. The first set of environmental components includes components that are shared within a respective node by the at least two peer-to-peer connected class-A ESP devices. The first set of environmental components are redundantly monitored and controlled in a manner as described earlier in the description.

At block 304, a second set of environmental components is redundantly monitored and controlled by at least two peer-to-peer connected class-B ESP devices, where the at least two peer-to-peer connected class-B ESP devices are in different nodes of the plurality of nodes 102. The second set of environmental components includes components that are shared between two nodes by the at least two peer-to-peer connected class-B ESP devices. The second set of environmental components are redundantly monitored and controlled in a manner as described earlier in the description.

At block 306, the monitoring and controlling of the first set of environmental components and the second set of environmental components are redundantly supervised by at least two peer-to-peer connected class-X EM devices. The at least two peer-to-peer connected class-X EM devices are in the different nodes. As mentioned earlier, each of the at least two peer-to-peer connected class-X EM devices in a node is peer-to-peer connected to the at least two class-A ESP devices and the at least one class-B ESP device of the node. The monitoring and controlling of the first set of environmental components and the second set of environmental components are redundantly supervised in a manner as described earlier.

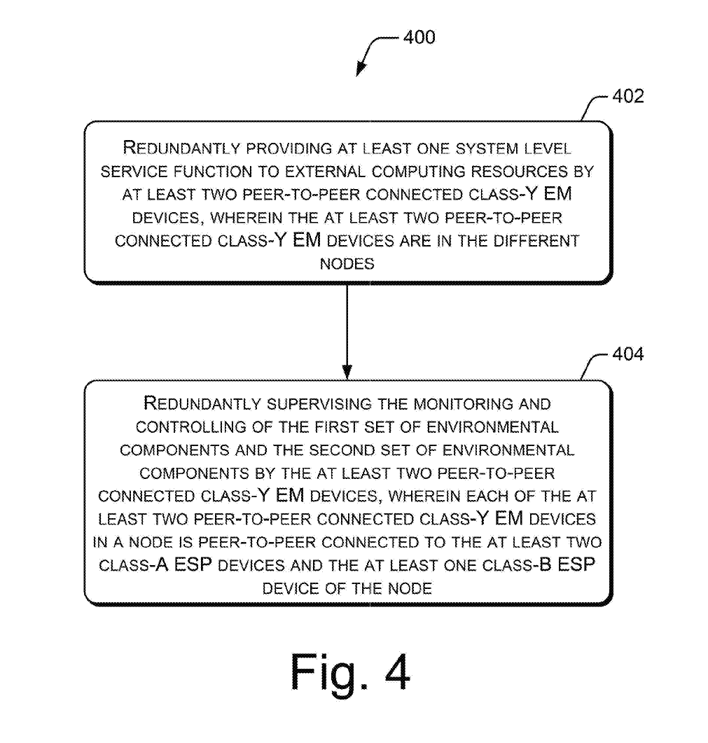

FIG. 4 illustrates a method 400 for managing a plurality of nodes in an enclosure of a storage system, according to an example implementation of the present subject matter. The order in which the method 400 is described is not intended to be construed as a limitation, and any number of the described method blocks can be combined in any order to implement the method 400. Furthermore, the method 400 can be implemented by processor(s) or computing device(s) through any suitable hardware, non-transitory machine readable instructions, or combination thereof. Further, although the method 400 is described in context of the aforementioned enclosure 100, other suitable computing devices or systems may be used for execution of at least one step of method 400. It may be understood that steps of method 400 can be executed based on instructions stored in a non-transitory computer readable medium, as will be readily understood. The non-transitory computer readable medium may include, for example, digital memories, magnetic storage media, such as a magnetic disks and magnetic tapes, hard drives, or optically readable digital data storage media.

In an example implementation, the method 400 may be executed in the enclosure 100 having the plurality of nodes 102 as shown in FIG. 2. Each of the plurality of nodes 102 includes at least two class-A ESP devices, at least one class-B ESP device, at least one class-X EM device, and at least one class-Y EM device. The connections and the description with respect to the class-A ESP devices, the class-B ESP devices, and the class-X EM devices are similar to that described earlier with reference to method 300. In addition, the at least one class-Y EM device in a node is peer-to-peer connected to the at least two class-A ESP devices and the at least one class-B ESP device in that node, and is also peer-to-peer connected to at least one class-Y EM device in another node.

Referring to FIG. 4, at block 402, at least one system level service function is redundantly provided to external computing resources by at least two peer-to-peer connected class-Y EM devices, where the at least two peer-to-peer connected class-Y EM devices are in the different nodes. The external computing resources may include client devices, and the system-level service function may include, but is not restricted to, a data storage service, a data computation service, and such.

At block 404, the monitoring and controlling of the first set of environmental components and the second set of environmental components are redundantly supervised by the at least two peer-to-peer connected class-Y EM devices. As mentioned earlier, each of the at least two peer-to-peer connected class-Y EM devices in a node is peer-to-peer connected to the at least two class-A ESP devices and the at least one class-B ESP device of the node.

As described earlier, at least two class-A ESP devices, at least one class-B ESP device, at least one class-X EM device and at least one class-Y EM device in a respective node, from among the plurality of nodes 102, form a set of devices in a communication mesh. In an example implementation, for the purposes of redundantly monitoring and controlling, and redundantly supervising the monitoring and controlling of various components in the nodes 102, health status information of the first set of environmental components is communicated to at least one device of the set of devices in the communication mesh by each of the at least two class-A ESP devices in the respective node. Also, health status information of the second set of environmental components is communicated to at least one device of the set of devices in the communication mesh by the at least one class-B ESP device in the respective node. Further, a heart-beat signal indicating a device functional status is generated by each of the at least two class-A ESP devices, the at least one class-B ESP device, the at least one class-X EM device and the at least one class-Y EM device in the communication mesh, where the heart-beat signal is communicated to at least one device of the set of devices in the communication mesh. In an example implementation, each of the at least two class-A ESP devices, the at least one class-B ESP device, the at least one class-X EM device and the at least one class-Y EM device in the communication mesh possesses a unique device ID, which is communicated along with the health status information and the heart-beat signal. The redundant monitoring and controlling, and redundant supervision, is performed based on the health status information, the heart-beat signal, and the unique device ID, in a manner as described earlier in the description.

In an example implementation, a component management action can be initiated by each of the at least two class-A ESP devices and the at least one class-B ESP device, respectively, on an environmental component from the first set of environmental components and the second set of environmental components. The component management action is initiated based on the health status information of the environmental component. Further, when the component management action is not initiated by one of the at least two class-A ESP devices and the at least one class-B ESP device, respectively, the component management action can be initiated by one of the class-X EM device and the class-Y EM device.

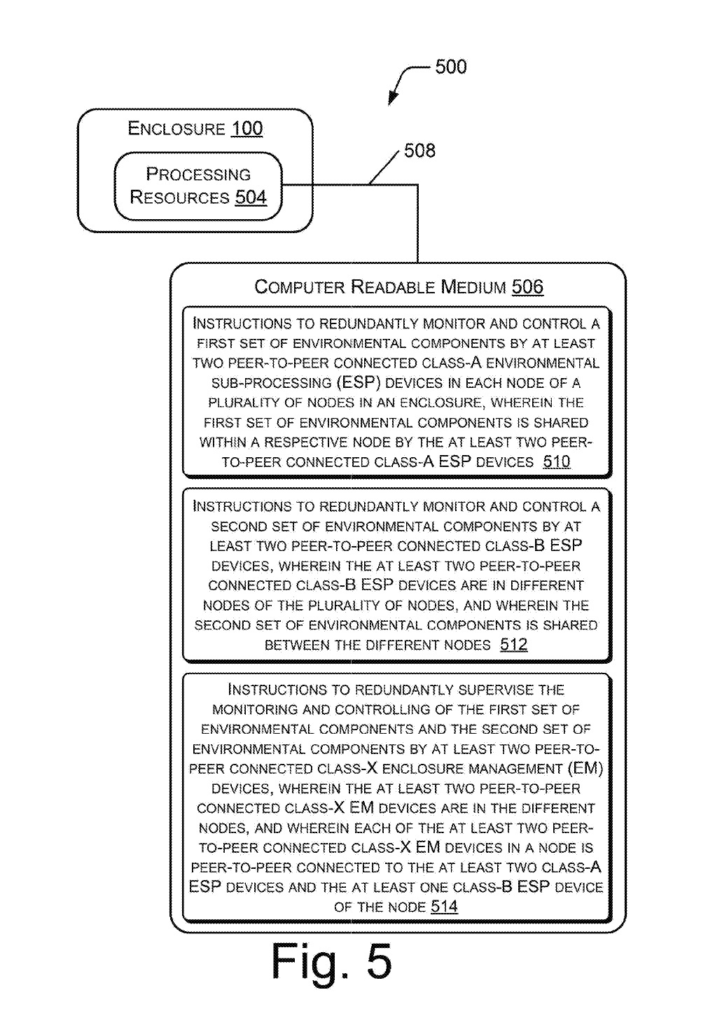

FIG. 5 illustrates an example system environment 500 for managing a plurality of nodes in an enclosure 100 of a storage system, according to an example implementation of the present subject matter. In an example implementation, the enclosure 100 of the system environment 500 includes processing resources 504 communicatively coupled to a non-transitory computer readable medium 506 through a communication link 508. In an example implementation, each node in the enclosure 100 may include at least two class-A ESP devices, at least one class-B ESP device, at least one class-X EM device, and at least one class-Y EM device. The class-A ESP devices, the class-B ESP devices, the class-X EM devices, and the class-Y EM devices in the nodes of the enclosure 100 are peer-to-peer connected in a manner as described earlier in the description. The processing resources 504 herein may refer to the processors of the class-A ESP devices, the class-B ESP devices, the class-X EM devices, and the class-Y EM devices in the nodes of the enclosure 100.

The non-transitory computer readable medium 506 can be, for example, an internal memory device or an external memory device. In an example implementation, the communication link 508 may be a direct communication link, such as any memory read/write interface. In another example implementation, the communication link 508 may be an indirect communication link, such as a network interface. In such a case, the processing resources 504 can access the non-transitory computer readable medium 506 through a network (not shown). The network may be a single network or a combination of multiple networks and may use a variety of different communication protocols.

In an example implementation, the non-transitory computer readable medium 506 includes a set of computer readable instructions for managing a plurality of nodes in the enclosure 100. The set of computer readable instructions can be accessed by the processing resources 504 through the communication link 508 and subsequently executed to perform acts for managing the plurality of nodes in the enclosure 100.

Referring to FIG. 5, in an example, the non-transitory computer readable medium 506 includes instructions 510 that cause the processing resources 504 to redundantly monitor and control a first set of environmental components by at least two peer-to-peer connected class-A ESP devices in each node of the plurality of nodes, where the first set of environmental components is shared within a respective node by the at least two peer-to-peer connected class-A ESP devices. The non-transitory computer readable medium 506 includes instructions 512 that cause the processing resources 504 to redundantly monitor and control a second set of environmental components by at least two peer-to-peer connected class-B ESP devices, where the at least two peer-to-peer connected class-B ESP devices are in different nodes of the plurality of nodes, and where the second set of environmental components is shared between the different nodes. The non-transitory computer readable medium 506 includes instructions 514 that cause the processing resources 504 to redundantly supervise the monitoring and controlling of the first set of environmental components and the second set of environmental components by at least two peer-to-peer connected class-X EM devices, where the at least two peer-to-peer connected class-X EM devices are in the different nodes, and where each of the at least two peer-to-peer connected class-X EM devices in a node is peer-to-peer connected to the at least two class-A ESP devices and the at least one class-B ESP device of the node.

In an example implementation, the non-transitory computer readable medium 506 may further include instructions that cause the processing resources 504 to redundantly provide at least one system level service function to external computing resources, and redundantly supervise the monitoring and controlling of the first set of environmental components and the second set of environmental components by at least two peer-to-peer connected class-Y EM devices, where the at least two peer-to-peer connected class-Y EM devices are in the different nodes, and where each of the at least two peer-to-peer connected class-Y EM devices in a node is peer-to-peer connected to the at least two class-A ESP devices and the at least one class-B ESP device of the node.

Although implementations for managing a plurality of nodes in an enclosure of a storage system have been described in language specific to structural features and/or methods, it is to be understood that the present subject matter is not necessarily limited to the specific features or methods described. Rather, the specific features and methods are disclosed and explained as example implementations for managing the plurality of nodes in the enclosure of the storage system.

We claim:

1. An enclosure of a storage system, the enclosure comprising a plurality of nodes, wherein each of the plurality of nodes comprises:
at least two class-A environmental sub-processing (ESP) devices peer-to-peer connected to each other to redundantly monitor and control a first set of environmental components shared within a respective node by the at least two class-A ESP devices;
at least one class-B ESP device peer-to-peer connected to at least one class-B ESP device of another node in the enclosure to redundantly monitor and control a second set of environmental components shared between the respective node and the other node; and
at least one class-X enclosure management (EM) device peer-to-peer connected to the at least two class-A ESP devices and the at least one class-B ESP device of the respective node, and to a class-X EM device of the other node to redundantly supervise the monitoring and controlling of the first set of environmental components and the second set of environmental components.

2. The enclosure as claimed in claim 1, wherein each of the plurality of nodes comprises at least one class-Y EM device to provide at least one system-level service function to external computing resources, and wherein the at least one class-Y EM device of the respective node is:
peer-to-peer connected to the at least two class-A ESP devices and the at least one class-B ESP device of the respective node, and to a class-Y EM device of the other node to redundantly supervise the monitoring and controlling of the first set of environmental components and the second set of environmental components, and to redundantly provide the at least one system level service function to the external computing resources across the nodes.

3. The enclosure as claimed in claim 2, wherein the at least two class-A ESP devices, the at least one class-B ESP device, the at least one class-X EM device, and the at least one class-Y EM device form a set of devices in a communication mesh in the respective node, and wherein each of the at least two class-A ESP devices is to communicate health status information of the first set of environmental components to at least one device of the set of devices in the communication mesh, and wherein the at least one class-B ESP device is to communicate health status information of the second set of environmental components to at least one device of the set of devices in the communication mesh.

4. The enclosure as claimed in claim 3, wherein each of the at least two class-A ESP devices, the at least one class-B ESP device, the at least one class-X EM device and the at least one class-Y EM device in the communication mesh is to:
generate a heart-beat signal indicating a device functional status; and
communicate the heart-beat signal to at least one device of the set of devices in the communication mesh.

5. The enclosure as claimed in claim 3, wherein each of the at least two class-A ESP devices and the at least one class-B ESP device in the respective node is to initiate a component management action on an environmental component, respectively, from the first set of environmental components and the second set of environmental components, and wherein the component management action is initiated based on the health status information of the environmental component.

6. The enclosure as claimed in claim 5, wherein, when the component management action is not initiated by one of the at least two class-A ESP devices and the at least one class-B ESP device, respectively, at least one of the class-X EM device and the class-Y EM device is to initiate the component management action, and wherein the component management action is initiated by the at least one of the class-X EM device and the class-Y EM device based on the health status information of the environmental component.

7. The enclosure as claimed in claim 2, wherein each of the at least one class-X EM device of at least two of the plurality of nodes is connected to at least one network connector respectively, for connecting the at least one class-X EM device to one or more host devices through the at least one network connector, and wherein the one or more host devices are connected to monitor and control the first set of environmental components and the second set of environmental components using the one or more host devices.

8. The enclosure as claimed in claim 7, wherein the at least one class-Y EM device of at least two of the plurality of nodes is connected to the at least one network connector respectively, for connecting the at least one class-Y EM device to the one or more host devices through the at least one network connector, and wherein the one or more host devices are connected to monitor and control the first set of environmental components and the second set of environmental components using the one or more host devices.

9. The enclosure as claimed in claim 2, wherein the enclosure comprises a plurality of power domains, and wherein
the class-X EM devices in the plurality of nodes are powered by a power supply of a first power domain from the plurality of power domains;
the class-Y EM devices in the plurality of nodes are powered by a power supply of a second power domain from the plurality of power domains; and
the class-A ESP devices and class-B ESP devices in the plurality of nodes are powered by a power supply of a third power domain from the plurality of power domains.

10. A method for managing a plurality of nodes in an enclosure of a storage system, the method comprising:
redundantly monitoring and controlling a first set of environmental components by at least two peer-to-peer connected class-A environmental sub-processing (ESP) devices in each node of the plurality of nodes, wherein the first set of environmental components is shared within a respective node by the at least two peer-to-peer connected class-A ESP devices;
redundantly monitoring and controlling a second set of environmental components by at least two peer-to-peer connected class-B ESP devices, wherein the at least two peer-to-peer connected class-B ESP devices are in different nodes of the plurality of nodes, and wherein the second set of environmental components is shared between the different nodes; and
redundantly supervising the monitoring and controlling of the first set of environmental components and the second set of environmental components by at least two peer-to-peer connected class-X enclosure management (EM) devices, wherein the at least two peer-to-peer connected class-X EM devices are in the different nodes, and wherein each of the at least two peer-to-peer connected class-X EM devices in a node is peer-to-peer connected to the at least two class-A ESP devices and the at least one class-B ESP device of the node.

11. The method as claimed in claim 10 further comprising:
redundantly providing at least one system level service function to external computing resources by at least two peer-to-peer connected class-Y EM devices, wherein the at least two peer-to-peer connected class-Y EM devices are in the different nodes; and
redundantly supervising the monitoring and controlling of the first set of environmental components and the second set of environmental components by the at least two peer-to-peer connected class-Y EM devices, wherein each of the at least two peer-to-peer connected class-Y EM devices in a node is peer-to-peer connected to the at least two class-A ESP devices and the at least one class-B ESP device of the node.

12. The method as claimed in claim 11, wherein at least two class-A ESP devices, at least one class-B ESP device, at least one class-X EM device, and at least one class-Y EM device in a respective node form a set of devices in a communication mesh, wherein the method further comprises:
communicating health status information of the first set of environmental components to at least one device of the set of devices in the communication mesh by each of the at least two class-A ESP devices in the respective node;
communicating health status information of the second set of environmental components to at least one device of the set of devices in the communication mesh by the at least one class-B ESP device in the respective node; and
generating a heart-beat signal indicating a device functional status by each of the at least two class-A ESP devices, the at least one class-B ESP device, the at least one class-X EM device, and the at least one class-Y EM device in the communication mesh; and
communicating the heart-beat signal to at least one device of the set of devices in the communication mesh.

13. The method as claimed in claim 12 further comprising:
initiating a component management action by each of the at least two class-A ESP devices and the at least one class-B ESP device, respectively, on an environmental component from the first set of environmental components and the second set of environmental components, wherein the component management action is initiated based on the health status information of the environmental component; and
when the component management action is not initiated by one of the at least two class-A ESP devices and the at least one class-B ESP device, respectively, initiating the component management action by one of the class-X EM device and the class-Y EM device.

14. A non-transitory computer-readable medium comprising computer-readable instructions for managing a plurality of nodes in an enclosure of a storage system, wherein the computer readable instructions are executable by processing resources of the enclosure to:
redundantly monitor and control a first set of environmental components by at least two peer-to-peer connected class-A environmental sub-processing (ESP) devices in each node of the plurality of nodes, wherein the first set of environmental components is shared within a respective node by the at least two peer-to-peer connected class-A ESP devices;
redundantly monitor and control a second set of environmental components by at least two peer-to-peer connected class-B ESP devices, wherein the at least two peer-to-peer connected class-B ESP devices are in different nodes of the plurality of nodes, and wherein the second set of environmental components is shared between the different nodes; and
redundantly supervise the monitoring and controlling of the first set of environmental components and the second set of environmental components by at least two peer-to-peer connected class-X enclosure management (EM) devices, wherein the at least two peer-to-peer connected class-X EM devices are in the different nodes, and wherein each of the at least two peer-to-peer connected class-X EM devices in a node is peer-to-peer connected to the at least two class-A ESP devices and the at least one class-B ESP device of the node.

15. The non-transitory computer-readable medium as claimed in claim 14 further comprising computer-readable instructions executable by the processing resources to:
redundantly provide at least one system level service function to external computing resources and redundantly supervise the monitoring and controlling of the first set of environmental components and the second set of environmental components by at least two peer-to-peer connected class-Y EM devices, wherein the at least two peer-to-peer connected class-Y EM devices are in the different nodes, and wherein each of the at least two peer-to-peer connected class-Y EM devices in a node is peer-to-peer connected to the at least two class-A ESP devices and the at least one class-B ESP device of the node.
